(19) United States
(12) Patent Application Publication
(10) Pub. No.: US 2003/0152174 A1
(43) Pub. Date: Aug. 14, 2003

(54) Space-cover-time equalizer

(76) Inventor: Joseph P. Burke, Carlsbad, CA (US)

Correspondence Address: Qualcomm Incorporated, Patents Department, 5775 Morehouse Drive, San Diego, CA, 92121-1714, US

(21) Appl. No.: 10/339,912

(22) Filed: Jan. 10, 2003

Related U.S. Application Data
(60) Provisional application No. 60/347,732, filed on Jan. 11, 2002.

(51) Int. Cl. H04B 1/10

(52) U.S. Cl. 375/349; 375/350

(57) ABSTRACT

Techniques for efficient allocation of channelization codes are disclosed. In one aspect, a dedicated data channel is partitioned into a primary channel and a secondary channel. The rate of the primary channel is a relatively low fixed rate. The rate of the secondary channel varies over time in accordance with the rate of the dedicated channel data. In another aspect, a channelization code indicator is transmitted in the primary channel to identify the secondary channel. In yet another aspect, more than one secondary channel may be deployed. Various other aspects are also presented. These aspects have the benefit of efficient code resource allocation, resulting in increased support for users/and or channels, as well as increased system capacity.

### CLAIM OF PRIORITY UNDER 35 U.S.C.120

This application claims the benefit of U.S. provisional application No. 60/347,732, entitled “Space-Cover-Timer Equalizer,” by Joseph P. Burke, filed on Jan. 11, 2002 which is assigned to the assignee of the present invention. The disclosure of this provisional application is incorporated herein by reference.

### FIELD

The present invention relates generally to communications, and more specifically to a novel and improved method and apparatus for space-cover-time equalization in a data communication system.

### BACKGROUND

Wireless communication systems are widely deployed to provide various types of communication such as voice and data. These systems may be based on code division multiple access (CDMA), time division multiple access (TDMA), or some other modulation techniques. A CDMA system provides certain advantages over other types of systems, including increased system capacity.

A CDMA system may be designed to support one or more CDMA standards such as (1) the “TIA/EIA-95-B Mobile Station-Base Station Compatibility Standard for Dual-Mode Wideband Spread Spectrum Cellular System” (the IS-95 standard), (2) the standard offered by a consortium named “3rd Generation Partnership Project” (3GPP) and embodied in a set of documents including Document Nos. 3G TS 25.211, 3G TS 25.212, 3G TS 25.213, and 3G TS 25.214 (the W-CDMA standard), (3) the standard offered by a consortium named “3rd Generation Partnership Project 2” (3GPP2) and embodied in “TR-45.5 Physical Layer Standard for cdma2000 Spread Spectrum Systems” (the IS-2000 standard), (4) a data-only communication system such as the high data rate (HDR) system that conforms to the TIA/EIA/IS-856 standard (the IS-856 standard), (5) a system combining features of a system like the IS-2000 standard with features similar to the IS-856 standard, such as detailed in documents entitled “Updated Joint Physical Layer Proposal for 1×EV-DV”, submitted to 3GPP2 as document number C50-20010611-009, Jun. 11, 2001; “Results of L3NQS Simulation Study”, submitted to 3GPP2 as document number C50-20010820-011, Aug. 20, 2001; “System Simulation Results for the L3NQS Framework Proposal for cdma2000 1×EV-DV”, submitted to 3GPP2 as document number C50-20010820-012, Aug. 20, 2001, and related documents generated subsequently (the 1×EV-DV proposal), and (6) other standards.

A common technique in mobile stations is to deploy a RAKE receiver to combine multi-path signals on the forward link to maximize the received signal Carrier-to-Interference plus Noise Ratio (CINR). The RAKE receiver coherently adds together the multi-path signals arriving at the mobile station at different time offsets. A RAKE receiver essentially performs a matched filter function for the channel. A matched filter provides good performance when the channel is noise limited.

On a CDMA forward link, self-multipath can dominate the interference seen by a user. For example, if a pilot signal is sent at constant power, a mobile station located close to the base station may receive the pilot with high power relative to the background noise. A RAKE receiver may be sub-optimal to an equalizer that treats the arriving multipath as self Inter-Chip-Interference (ICI) with the goal of equalizing the channel. When multiple antennas are employed in the mobile station, the equalizer may take the form of a space-time (S-T) equalizer. Using a known pilot training sequence in a CDMA system, the S-T equalizer will outperform the multi-antenna RAKE receiver in frequency selective channels with large multi-path powers relative to background noise. S-T equalizers are well known in the art.

A mobile station in soft handoff receives signals from two or more sectors, from one or more base stations. A common technique to distinguish signals from different sectors is to cover those signals using a unique PN code for each sector. An S-T equalizer may use the pilot sequence from a sector, which is covered by a sector-specific PN code, in dynamically generating weights for equalizing that channel. Thus, to use S-T equalization techniques, a plurality of S-T equalizers are deployed to receive a plurality of signals from different sectors in soft handoff. This configuration of a per-sector S-T equalizer used with a RAKE combiner for all sectors strongly outperforms the standard RAKE receiver architecture in certain environments. One drawback, however, is the complexity and cost associated with deploying multiple S-T equalizers to accommodate soft handoff. It would be advantageous to receive multi-sector transmission, such as in soft handoff, with reduced complexity for a given level of performance.

Another limitation is that equalization is performed for each sector separately, without taking into account potentially useful information from the other sectors. It would be advantageous to take into account cover diversity in an equalizer, in addition to spatial diversity and time diversity to provide improved communications performance. There is therefore a need in the art for receivers that can equalize across multiple sectors efficiently and with improved performance.

### SUMMARY

Embodiments disclosed herein address the need for receivers that can equalize across multiple sectors efficiently and with improved performance. In one aspect, signals received from multiple sectors, and covered with sector-specific codes, are decovered with those codes and recovered with a base code (i.e., in effect re-correlating the signals transmitted from multiple sectors). In another aspect, space-cover-time (S-C-T) equalization is performed on the recorrelated signals, accounting for cover diversity as well as spatial and time diversity. In yet another aspect, a single space-time equalizer is deployed to equalize per-antenna combined, re-correlated signals. In yet another aspect, multi-sector transmitted signals are received at a single antenna, recorrelated, and cover-time (C-T) equalized. Various other aspects are also presented. These aspects have the benefit of increasing communication performance via increased diversity, and/or decreasing complexity for a desired level of communication performance.

The invention provides methods and system elements that implement various aspects, embodiments, and features of the invention, as described in further detail below.

### BRIEF DESCRIPTION OF THE DRAWINGS

The features, nature, and advantages of the present invention will become more apparent from the detailed description set forth below when taken in conjunction with the drawings in which like reference characters identify correspondingly throughout and wherein:

FIG. 1 is a general block diagram of a wireless communication system capable of supporting a number of users;

FIG. 2 shows a portion of a prior art mobile station configured for performing S-T equalization in soft handoff;

FIG. 3 shows a portion of a mobile station configured for performing S-C-T equalization in soft handoff;

FIG. 4 depicts an example decover/recover block;

FIG. 5 depicts a flowchart of an example embodiment of a method of space-cover-time equalization;

FIG. 6 depicts an example embodiment of a portion of a mobile station including a cover domain combiner with a single S-T equalizer;

FIG. 7 depicts an example sector combiner;

FIG. 8 depicts a flowchart of an example embodiment of a method of equalizing across multiple sectors using cover combining and a single S-T equalizer;

FIG. 9 depicts an example of a portion of a mobile station comprising a plurality of cover-time equalizers;

FIG. 10 depicts a flowchart of an example embodiment of a method of equalizing across multiple sectors using a plurality of cover-time equalizers;

FIG. 11 depicts an embodiment of a portion of a mobile station using a single antenna and a cover-time equalizer;

FIG. 12 depicts a flowchart of an example embodiment of a method of equalizing across multiple sectors using one cover-time equalizer;

FIG. 13 depicts a more detailed embodiment of a portion of a mobile station comprising an S-C-T equalizer; and

FIG. 14 depicts a flowchart of a more detailed example embodiment of a method of S-C-T equalization.

### DETAILED DESCRIPTION

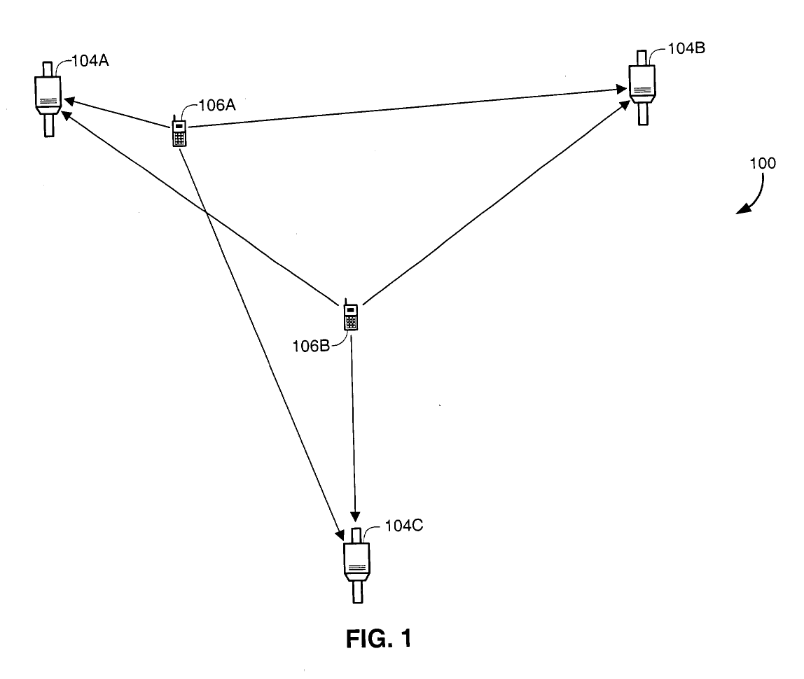

FIG. 1 is a diagram of a wireless communication system 100 that may be designed to support one or more CDMA standards and/or designs (e.g., the W-CDMA standard, the IS-95 standard, the cdma2000 standard, the HDR specification, the 1×EV-DV proposal). In an alternative embodiment, system 100 may also deploy any wireless standard or design other than a CDMA system, such as a GSM system.

For simplicity, system 100 is shown to include three base stations 104 in communication with two mobile stations 106. The base station and its coverage area are often collectively referred to as a “cell”. In IS-95 systems, a cell may include one or more sectors. In the W-CDMA specification, each sector of a base station and the sector's coverage area is referred to as a cell. As used herein, the term base station can be used interchangeably with the terms access point or Node B. The term mobile station can be used interchangeably with the terms user equipment (UE), subscriber unit, subscriber station, access terminal, remote terminal, or other corresponding terms known in the art. The term mobile station encompasses fixed wireless applications.

Depending on the CDMA system being implemented, each mobile station 106 may communicate with one (or possibly more) base stations 104 on the forward link at any given moment, and may communicate with one or more base stations on the reverse link depending on whether or not the mobile station is in soft handoff. The forward link (i.e., downlink) refers to transmission from the base station to the mobile station, and the reverse link (i.e., uplink) refers to transmission from the mobile station to the base station.

For clarity, the examples used in describing this invention may assume base stations as the originator of signals and mobile stations as receivers and acquirers of those signals, i.e. signals on the forward link. Those skilled in the art will understand that mobile stations as well as base stations can be equipped to transmit data as described herein and the aspects of the present invention apply in those situations as well. The word “exemplary” is used exclusively herein to mean “serving as an example, instance, or illustration.” Any embodiment described herein as “exemplary” is not necessarily to be construed as preferred or advantageous over other embodiments.

A common technique in prior art mobile stations is to deploy a RAKE receiver to combine multi-path signals on the forward link to maximize the received signal Carrier-to-Interference plus Noise Ratio (CINR). The RAKE receiver coherently adds together the multi-path signals arriving at the mobile station at different time offsets. A RAKE receiver can be deployed in a base station for receiving reverse link multi-path signals as well. A RAKE receiver essentially performs a matched filter function for the channel. A matched filter provides good performance when the channel is noise limited.

On a CDMA forward link, self-multipath can dominate the interference seen by a user. For example, if a pilot signal is sent at constant power, a mobile station located close to the base station may receive the pilot with high power relative to the background noise. A RAKE receiver may be sub-optimal to an equalizer that treats the arriving multipath as self Inter-Chip-Interference (ICI) with the goal of equalizing the channel. When multiple sensors or antennas are employed in the mobile station, the equalizer takes the form of a space-time (S-T) equalizer. Using a known pilot training sequence in a CDMA system, the S-T equalizer will outperform the multi-antenna RAKE receiver in frequency selective channels with large multi-path powers relative to background noise. S-T equalizers are well known in the art.

A mobile station in soft handoff receives signals from two or more sectors, from one or more base stations. A common technique to distinguish signals from different sectors is to cover those signals using a unique PN code for each sector. As described above, an S-T equalizer uses the pilot sequence from a sector, which is covered by that sectors PN code, in dynamically generating weights for equalizing that channel. Thus, to use S-T equalization techniques, in the prior art, a plurality of S-T equalizers are deployed to receive a plurality of signals from different sectors in soft handoff. Each per-sector S-T equalizer will see adjacent sector signals as uncorrelated co-channel interference (CCI). Data signals transmitted from adjacent sectors may also be covered with a different Walsh-Hadamard (Walsh) cover or Orthogonal Variable Spreading Factor (OVSF) cover.

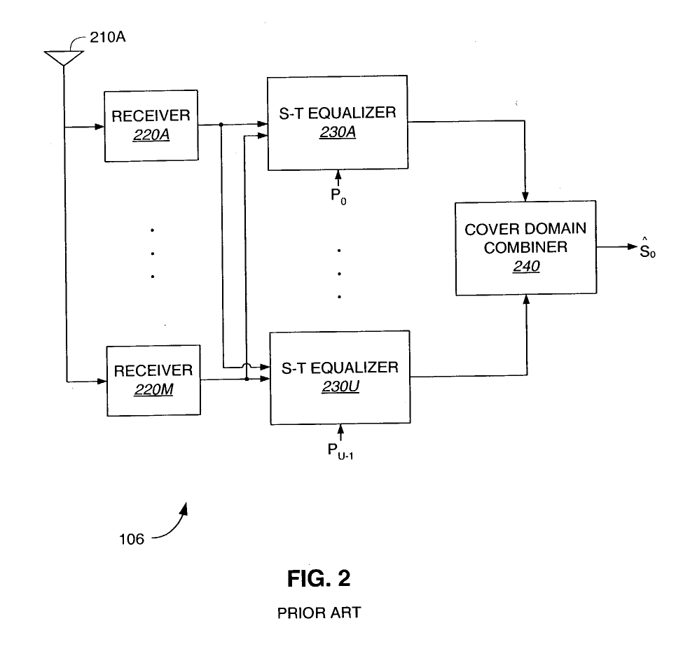

FIG. 2 shows a portion of a prior art mobile station 106 configured for performing S-T equalization in soft handoff. In this example, M antennas 210A-210M are deployed to provide spatial diversity. Signals from surrounding sectors are received and converted to baseband in RF downconversion blocks 220A-220M, to provide M received signals. RF downconversion techniques are well known in the art and may include frequency downconversion, filtering, amplification, or Analog-to-Digital (A/D) conversion, among others. The M received signals are delivered to U S-T equalizers 230A-230U, to support U different sectors. S-T equalizers 230A-230U use PN codes P₀-P_{U}, respectively, to equalize the U sector's channels. The outputs of the U S-T equalizers 230A-230U are combined in cover domain combiner 240 to produce the received signal estimate ŝ₀. In an example cover domain combiner, the per-sector PN code is used to decover the respective output of each S-T equalizer 230. In addition, channelization codes, such as Walsh codes or Orthogonal Variable Spreading Factor (OVSF) codes may be decovered. A RAKE combiner may be deployed as cover domain combiner 240. Once the various signals are normalized with respect to PN code and channel covering, the signals can be combined. The received signal estimate ŝ₀ may be used for further processing such as additional demodulation, decoding, deinterleaving, and the like.

It may be quite common for a mobile station to operate in soft handoff. In practice, a mobile station may be in two-sector handoff approximately 40% of the time. During soft handoff, a per sector S-T equalizer used with a RAKE combiner for all sectors strongly outperforms the standard RAKE receiver architecture. One drawback is the complexity and cost associated with deploying multiple S-T equalizers to accommodate soft handoff. Another limitation is that equalization is performed for each sector separately—without taking into account potentially useful information from the other sectors. Some of the embodiments disclosed herein provide similar or improved performance, with respect to the receiver of FIG. 2, with reduced complexity. Other embodiments described herein take into account spatial diversity, time diversity, and/or cover diversity (i.e. signals from more than one sector in soft handoff) to provide improved communications performance.

A Space-Cover-Time (S-C-T) equalizer, as described herein, performs equalization of the channel, including various paths from one or more sectors or base stations. The S-C-T equalizer operates with signals that are correlated across sectors using a base sector PN code and Walsh cover (i.e. decovering and recovering). The decovered/recovered signals are treated as correlated signal inputs to the S-C-T equalizer. The signals from various sectors are thereby used to yield full equalization in handoff across antennas, sectors, and time.

Received signals from each of M antennas are delivered for decovering with U PN codes, each PN code corresponding to one of U sectors, and recovering with a base PN code, to produce M*U sector normalized received signals. The M antennas provide special diversity, while the U sectors provide cover diversity. The M*U signals are sampled and stored for a period of time, N, to provide time diversity. Weight values may then be computed in response to the M*U*N samples, detailed further below, for use in S-C-T equalization. In an example embodiment, the weight values may be determined using a least squares method, and may be used to determine tap values for a FIR filter. Note that, in contrast to per-sector S-T equalization, in which weight values are computed using only space and time diversity for one sector, the weight values for the S-C-T equalizer are based on the space and time diversity for all the sectors.

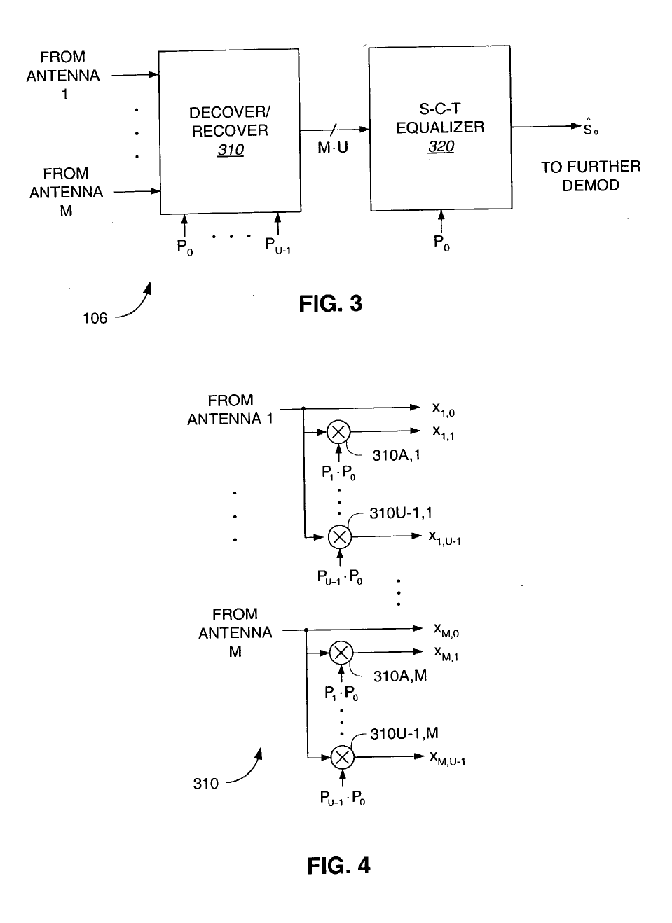

FIG. 3 shows a portion of a mobile station 106 configured for performing S-C-T equalization in soft handoff. Signals from M antennas (i.e. antennas 210A-210M in conjunction with receivers 220A-220M, details not shown), are delivered for decovering and recovering in decover/recover block 310. Each of the M signals is decovered using each sector PN code, P₁-P_{U-1}, and then recovered using the base PN code, P₀, (note that decovering and recovering is not necessary for a sector code that is identical to the base PN code). Decover/recover block 310 is detailed further below with respect to FIG. 4. Decovering and recovering signals from M antennas for U sectors produces M*U output signals, which are delivered to S-C-T equalizer 320. The S-C-T equalizer 320 determines weights in response to the M*U input signals and the base PN code, P₀, and generates an estimated received signal estimate, ŝ₀, by equalizing the inputs using those weights (example embodiments are detailed further below). S-C-T equalizer 320 may be configured to remove the base PN and Walsh covers, or additional components may be deployed to PN despread and Walsh decover (details not shown). The output, ŝ₀, may then be delivered for further demodulation. Examples of additional demodulation steps include accumulating ŝ₀ to generate a symbol, deinterleaving, decoding, and other demodulation techniques known in the art.

FIG. 4 depicts an example decover/recover block 310. It includes M*U-1 multipliers 310A, 1-310U-1,1 through 310A,M-310U-1,M. The multiplying sequences for each of the M*U-1 multipliers 310A-310U-1 are formed by multiplying a base PN code of one sector, P₀, by the PN codes for the remaining sectors, P₁-P_{U-1}, respectively. The decovered/recovered signals, x_{1,0}-x_{M,U-1}, may be delivered to S-C-T equalizer 320. Decover/recover block may be used in configurations deploying different equalizers as well, examples of which are detailed below. Note that the M received signals are delivered as outputs without decovering and recovering, since the base sector is covered with the base PN code, P₀.

In the example embodiment just described, the base PN code is selected as one of the PN codes of the received sectors. This allows the use of M*U-1 decover/recover blocks 310. In an alternate embodiment, an arbitrary base PN code may be selected, and an additional M decover/recover blocks 310 may be deployed to normalize the remaining sector.

Furthermore, the example just described is simplified using the common technique assigning the all zero spreading sequence for pilots from sectors, i.e. W₀. Those of skill in the art will recognize that the decover/recover process can be performed to decover using any Walsh function and recover with any arbitrary base Walsh function. These details are not included for clarity of instruction. Those of skill in the art will readily adapt embodiments herein accordingly in light of the discussion herein.

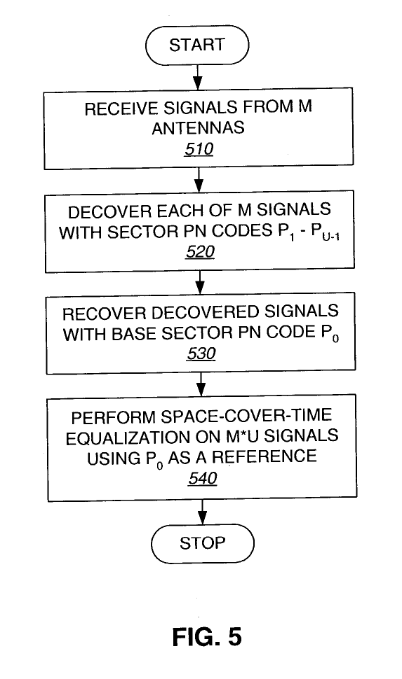

FIG. 5 depicts a flowchart of an example embodiment of a method of space-cover-time equalization. The process begins at step 510, where signals are received from M antennas. Proceed to step 520. In step 520, each of the M received signals is decovered with U-1 sector PN codes, P₁-P_{U-1}, to produce (M-1)*U decovered signals. In this embodiment, one of the sectors is covered with a base PN code, P₀. Thus, the M inputs need not be decovered with the base PN sequence, as described above. In an alternate embodiment, an arbitrary base PN sequence could be used, and thus PN sequences for all U sectors would be used for decovering. Proceed to step 530.

In step 530, the decovered signals are recovered using the base PN sequence, P₀. Thus, the additional sectors used in soft handoff will be correlated with the base sector. Note again, that the M signals not decovered need not be recovered, as they are already covered with the base PN sequence. Proceed to step 540.

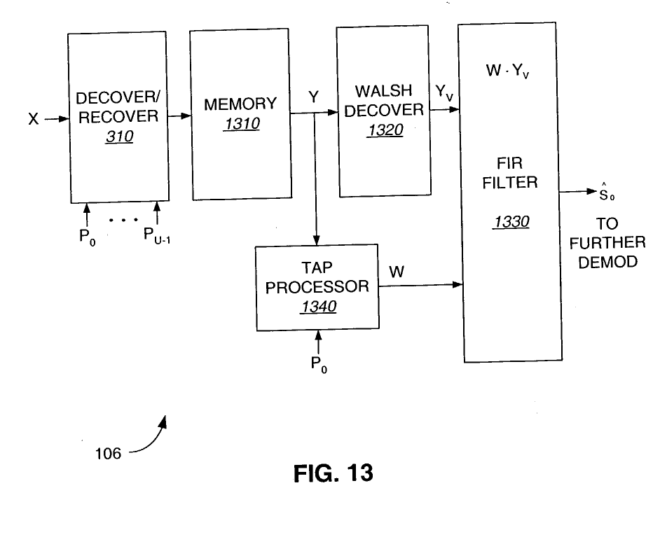

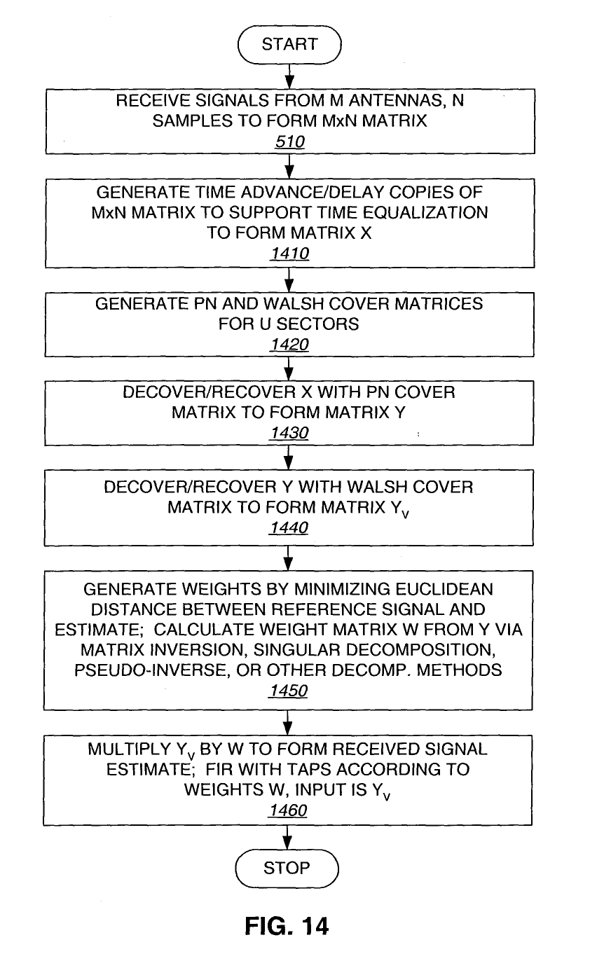

In step 540, perform space-cover-time equalization on the M*U signals (including the decovered and recovered signals, as well as the M input signals), using the base PN sequence, P₀, as a reference. An example procedure for performing S-C-T equalization is detailed below with respect to FIGS. 13-14. Then the process may stop. Note that equalization will produce received signal estimates which can be delivered for further demodulation, such as accumulation of a symbol, deinterleaving, decoding, and various other demodulation techniques known in the art. The process depicted in FIG. 5 may be repeated indefinitely for as long as a mobile station desires to receive a transmitted channel (details not shown). Alternatively, any iterative period can be deployed. As an example, the equalizer may be updated every N time samples, where N corresponds to changing channel conditions.

Full S-C-T equalization provides the benefits of equalizing across all sectors, antennas, and time. However, in certain situations, it may be desirable to deploy a subset of the S-C-T equalizer. The decover/recover technique may be applied with a single S-T equalizer to perform S-T equalizing of multiple sectors in soft handoff. This is in contrast to the architecture described with respect to FIG. 2, above, wherein multiple S-T equalizers were required for combining multiple sectors.

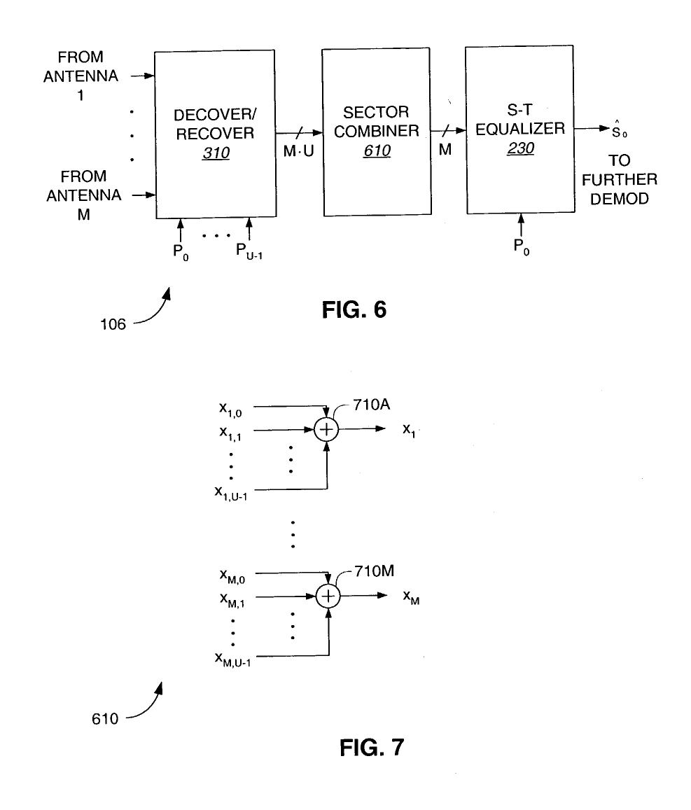

FIG. 6 depicts an example embodiment of a portion of mobile station 106 including a cover domain combiner with a single S-T equalizer, which provides comparable performance to the architecture depicted in FIG. 2. The received signals from the M antennas (receiver details not shown) are delivered to decover/recover block 310, which operates substantially as described above to produce M*U correlated signals. The M*U signals are delivered to sector combiner 610, which combines U sector signals per antenna to produce M cover combined signals, for delivery to S-T equalizer 230. Decover/recover block 310 and sector combiner 610 operate together to perform cover combining, i.e. correlating signals across multiple sectors (and corresponding PN covers) in accordance with a base PN sequence. One benefit of deploying a cover combiner is that a single S-T equalizer can be deployed in conjunction therewith to perform space-time equalization over multiple sectors, as in soft handoff, for example.

The cover combined signals are correlated according to the base PN sequence, P₀. The S-T equalizer functions substantially the same as described with respect to FIG. 2, above, using the base PN sequence, P₀, as a reference signal, equalizing the M cover combined signals to produce a received estimate, ŝ₀. S-T equalizer 230 may be configured to decover the base PN code and Walsh code, as desired. Alternately, additional components may be deployed to decover, as described above (details not shown). The output, ŝ₀, may then be delivered for further demodulation. Examples of additional demodulation steps include accumulating ŝ₀ to generate a symbol, deinterleaving, decoding, and other demodulation techniques known in the art.

FIG. 7 depicts an example sector combiner 610. The decovered and recovered signals are summed, per antenna. For example, decovered/recovered signals x_{1,0}-x_{1,U-1} are summed to produce signal x₁, corresponding to antenna 1. The process is repeated for each antenna using the respective signals, one signal for each sector included in the sum for that antenna. Thus, M adders 710A-710M are deployed to combine decovered/recovered signals x_{1,0}-x_{1,U-1} through x_{M,0}-x_{M,0}-x_{M,U-1}, to produce signals x₁-x_{M}, respectively.

In this fashion, the signals for each sector are correlated and combined, to produce one signal per antenna for delivery to the S-T equalizer 230. The embodiment depicted in FIG. 6 allows a single S-T equalizer 230 to be deployed to demodulate U sectors, in contrast with the U S-T equalizers required in a configuration as shown in FIG. 2. The example embodiment thus achieves similar performance using a more efficient architecture, resulting in reduced hardware costs, processing requirements, or a combination of the two.

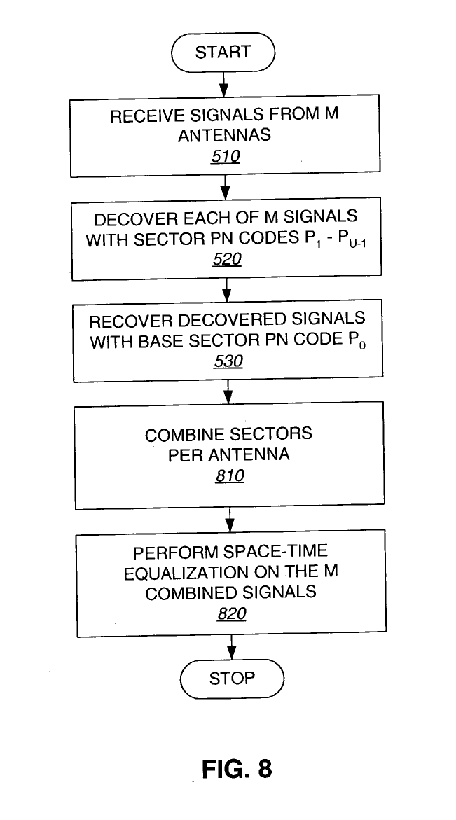

FIG. 8 depicts a flowchart of an example embodiment of a method of equalizing across multiple sectors using cover combining and a single S-T equalizer. The process begins in step 510. The first three steps operate substantially as described for the like referenced steps, described above with respect to FIG. 5. In step 510, signals are received from M antennas. Proceed to step 520. In step 520, each of the M received signals is decovered with U-1 sector PN codes, P₁-P_{U-1}, to produce (M-1)*U decovered signals. In this embodiment, one of the sectors is covered with a base PN code, P₀. Thus, the M inputs need not be decovered with the base PN sequence, as described above. In an alternate embodiment, an arbitrary base PN sequence could be used, and thus PN sequences for all U sectors would be used for decovering. Proceed to step 530.

In step 530, the decovered signals are recovered using the base PN sequence, P₀. Thus, the additional sectors used in soft handoff will be correlated with the base sector. Note again, that the M signals not decovered need not be recovered, as they are already covered with the base PN sequence. Proceed to step 810.

In step 810, instead of performing full space-cover-time equalization on the M*U signals, the signals are combined per antenna, each combined signal corresponding to the associated sector signals for that antenna, in like manner as described with respect to sector combiner 610, above. Proceed to step 820. In step 820, space-time equalization is performed on the M combined signals. S-T equalization techniques are known in the art. Then the process may stop. Note that equalization will produce received signal estimates which can be delivered for further demodulation, such as accumulation of a symbol, deinterleaving, decoding, and various other demodulation techniques known in the art. The process depicted in FIG. 8 may be repeated indefinitely for as long as a mobile station desires to receive a transmitted channel (details not shown). Alternatively, any iterative period can be deployed. As an example, the equalizer may be updated every N time samples, where N corresponds to changing channel conditions.

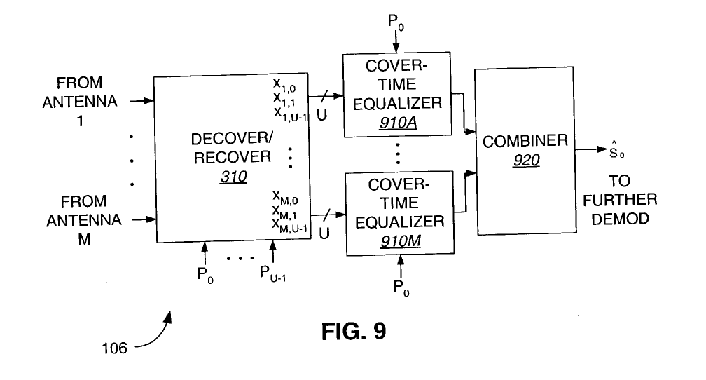

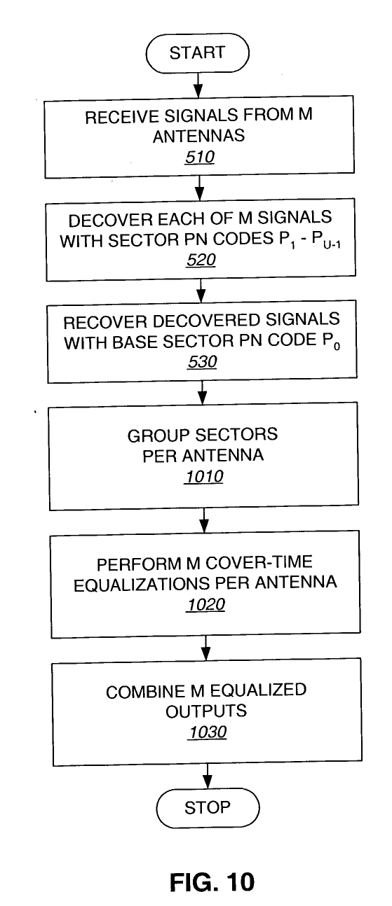

Another subset of full S-C-T equalization is to correlate signals across multiple sectors, generating sets of U signals for each antenna. Then cover-time equalizers may be deployed, one per antenna, to equalize the received signals corresponding to each antenna, followed by a combiner for combining the M equalized outputs. An example of a portion of a mobile station 106 comprising U cover-time equalizers is depicted in FIG. 9. The embodiment shown in FIG. 9 may be deployed as an alternative to the various embodiments described above, with varying performance trade-offs based on the environment in which they are deployed. A specific example of the general embodiment shown in FIG. 9 is a single antenna mobile station 106, which has certain advantages over other alternatives, detailed further below with respect to FIG. 10.

In FIG. 9, the received signals from M antennas (receiver details not shown) are delivered to decover/recover block 310, which operates substantially as described above to produce M*U correlated signals. The M*U signals are grouped per antenna, with U signals per group, and each group is delivered to a cover-time equalizer, 910A-910M, respectively. The decovered/recovered signals are correlated according to the base PN sequence, P₀. Each C-T equalizer 910 equalizes the correlated signals corresponding to its respective antenna using the base PN sequence, P₀, as a reference. The M outputs from C-T equalizers 910A-910M are delivered to combiner 920, which combines them to produce a received estimate, ŝ₀. The C-T equalizers may be configured to decover the base PN sequence and Walsh cover, if desired. Alternatively, combiner 920 may provide the decovering. In yet another alternative, a RAKE combiner may be deployed as combiner 920. The output, ŝ₀, may then be delivered for further demodulation. Examples of additional demodulation steps include accumulating ŝ₀ to generate a symbol, deinterleaving, decoding, and other demodulation techniques known in the art.

FIG. 10 depicts a flowchart of an example embodiment of a method of equalizing across multiple sectors using M cover-time equalizers. The process begins in step 510. The first three steps operate substantially as described for the like referenced steps, described above with respect to FIGS. 5 and 8. In step 510, signals are received from M antennas. Proceed to step 520. In step 520, each of the M received signals is decovered with U-1 sector PN codes, P₁-P_{U-1}, to produce (M-1)*U decovered signals. In this embodiment, one of the sectors is covered with a base PN code, P₀. Thus, the M inputs need not be decovered with the base PN sequence, as described above. In an alternate embodiment, an arbitrary base PN sequence could be used, and thus PN sequences for all U sectors would be used for decovering. Proceed to step 530.

In step 530, the decovered signals are recovered using the base PN sequence, P₀. Thus, the additional sectors used in soft handoff will be correlated with the base sector. Note again, that the M signals not decovered need not be recovered, as they are already covered with the base PN sequence. Proceed to step 1010.

In step 1010, instead of performing full space-cover-time equalization on the M*U signals, the signals are grouped per antenna, each group corresponding to the associated sector signals for that antenna, in like manner as described with respect to decover/recover block 310, above. Proceed to step 1020. In step 1020, cover-time equalization is performed on the M signal groups to form M outputs. Example C-T equalization techniques are detailed further below. Proceed to step 1030. In step 1030, the M equalized outputs are combined. Then the process may stop. Note that the combiner will produce received signal estimates which can be delivered for further demodulation, such as accumulation of a symbol, deinterleaving, decoding, and various other demodulation techniques known in the art. The process depicted in FIG. 10 may be repeated indefinitely for as long as a mobile station desires to receive a transmitted channel (details not shown). Alternatively, any iterative period can be deployed. As an example, the equalizer may be updated every N time samples, where N corresponds to changing channel conditions.

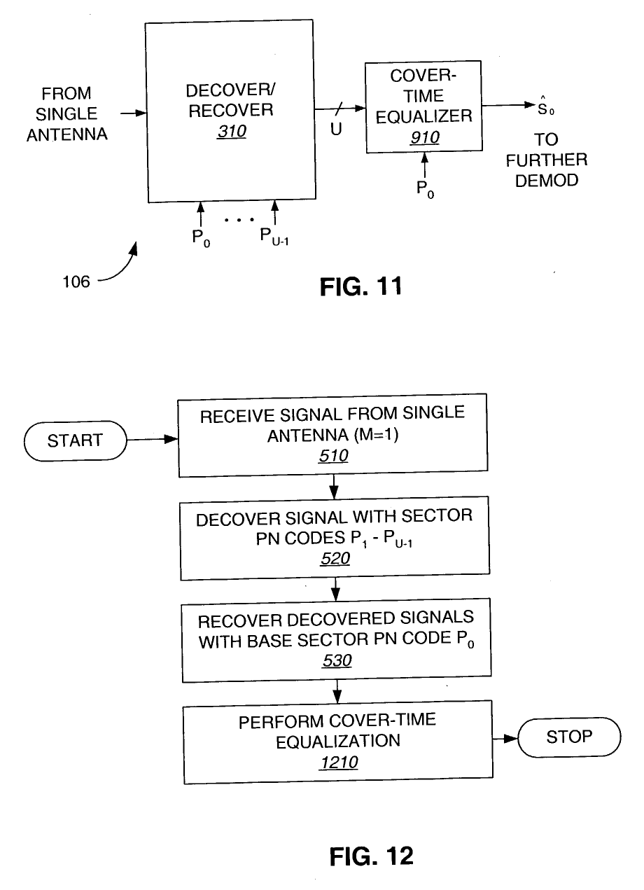

FIG. 11 depicts an embodiment of a portion of a mobile station 106 using a single antenna and a cover-time equalizer. This embodiment is a subset of the embodiment described with respect to FIG. 9, with M=1. In FIG. 11, the received signal from one antenna (receiver details not shown) is delivered to decover/recover block 310, which operates substantially as described above to produce U correlated signals. The U signals are delivered to a cover-time equalizer 910. The decovered/recovered signals are correlated according to the base PN sequence, P₀. The C-T equalizer 910 equalizes the correlated signals using the base PN sequence, P₀, as a reference, to produce a received estimate, ŝ₀. The C-T equalizer may be configured to decover the base PN sequence and Walsh cover, if desired. Alternately, additional components may be deployed to decover, as described above (details not shown). The output, ŝ₀, may then be delivered for further demodulation. Examples of additional demodulation steps include accumulating ŝ₀ to generate a symbol, deinterleaving, decoding, and other demodulation techniques known in the art.

The embodiment of FIG. 11 may prove advantageous over other embodiments when only a single antenna is available. (Note that this embodiment provides equivalent performance to a full S-C-T equalizer, since M=1. Thus the S-C-T equalizer collapses to a C-T equalizer.) Using multiple correlated sector inputs provides multiple sensors for equalization. As is well known in the art, a single sensor solution calls for an Infinite Impulse Response (IIR) filter to equalize the channel. In practice, IIR filters are commonly truncated to a fixed length to approximate the IIR filter. By contrast, multi-sensor inputs provide for possible deployment of a Finite Impulse Response (FIR) filter to equalize the channel, as the multiple sensors provide more than one degree of freedom. Thus, for a fixed number of taps, the multi-sensor FIR filter may provide superior performance to multiple single sensor IIR filters. Alternatively, for a desired performance level, the FIR may be implemented using fewer taps, allowing for reduced complexity and cost. Therefore, with a single-antenna mobile station, decovering and recovering multiple sectors and performing C-T equalization may outperform an alternate solution that equalizes each sector independently and then combines the equalized results.

FIG. 12 depicts a flowchart of an example embodiment of a method of equalizing across multiple sectors using one cover-time equalizer. The process begins in step 510. The first three steps operate substantially as described for the like referenced steps, described above with respect to FIGS. 5, 8, and 10. In this case, however, M=1. In step 510, a signal is received from the antenna. Proceed to step 520. In step 520, the received signal is decovered with U-1 sector PN codes, P₁-P_{U-1}, to produce U-1 decovered signals. As before, in this embodiment, one of the sectors is covered with a base PN code, P₀. Thus, the input need not be decovered with the base PN sequence, as described above. In an alternate embodiment, an arbitrary base PN sequence could be used, and thus PN sequences for all U sectors would be used for decovering. Proceed to step 530.

In step 530, the decovered signals are recovered using the base PN sequence, P₀. Thus, the additional sectors used in soft handoff will be correlated with the base sector. Note again, that the signal not decovered need not be recovered, as it is already covered with the base PN sequence. Proceed to step 1210.

In step 1210, cover-time equalization is performed on the U sectors to provide a received estimate. Then the process may stop. Note that the received signal estimates may be delivered for further demodulation, such as accumulation of a symbol, deinterleaving, decoding, and various other demodulation techniques known in the art. The process depicted in FIG. 12 may be repeated indefinitely for as long as a mobile station desires to receive a transmitted channel (details not shown). Alternatively, any iterative period can be deployed. As an example, the equalizer may be updated every N time samples, where N corresponds to changing channel conditions.

FIG. 13 depicts a more detailed embodiment of a portion of a mobile station 106 comprising an S-C-T equalizer in conjunction with decovering and recovering. This figure will be referenced throughout the discussion below, which details example techniques for performing S-C-T equalization. In addition, embodiments using a subset of S-C-T equalization, such as those described above with respect to FIGS. 6-12, may be deployed. Those of skill in the art will readily adapt the embodiment of FIG. 13 to perform these additional embodiments, as well as myriad combinations of the embodiments and techniques disclosed herein.

In FIG. 13, received signals from M antennas, represented as matrix X, are delivered to decover/recover block 310. Decover/recover block 310 operates substantially as described above. Each of the M signals is decovered using each sector PN code, P₁-P_{U-1}, and then recovered using the base PN code, P₀. Each row of matrix X corresponds to a number of received samples, N. As detailed further below, X may include multiple hypotheses, for example, one or more early hypotheses and one or more late hypotheses, in addition to an on-time hypothesis. Those of skill in the art will recognize that multiple hypotheses can be generated by storing various data offsets in matrix X, or equivalently storing one set of input data and decovering and recovering with advanced or retarded versions of the various PN sequences. This notation is for clarity of discussion, and will be apparent in the detailed discussion below. The decovered and recovered signals are stored in memory 1310. These signals are represented as matrix Y.

Y is delivered to tap processor 1340, which generates weight values, represented as matrix W, using the base PN sequence P₀ as a reference. Tap processor 1340 may be a general-purpose microprocessor, a digital signal processor (DSP), or a special-purpose processor. Tap processor 1340 may perform some or all of the various functions described with respect to FIG. 13, as well as any other processing required by the mobile station 106. Tap processor 1340 may be connected with special-purpose hardware to assist in these tasks (details not shown). Data or voice applications may be performed in mobile station 106, and may be external, such as an externally connected laptop computer or connection to a network, may run on an additional processor within mobile station 106 (not shown), or may run on tap processor 1340 itself. Tap processor 1340 is connected with memory 1310, which may be used for storing data as well as instructions for performing the various procedures and methods described herein. Those of skill in the art will recognize that memory 1310 may be comprised of one or more, memory components of various types, that may be embedded in whole or in part within tap processor 1310. Weight matrix W is delivered to FIR filter 1330.

Y is also delivered to Walsh Decover 1320. Walsh Decover 1320 decovers Y using the sector specific Walsh codes to produce matrix Y_{V}. Y_{V} is delivered to FIR filter 1330. FIR filter 1330 multiplies W by Y_{V} to produce the received estimate, ŝ₀, The output, ŝ₀, may then be delivered for further demodulation. Examples of additional demodulation steps include accumulating ŝ₀ to generate a symbol, deinterleaving, decoding, and other demodulation techniques known in the art.

Tap processor 1340 and FIR filter 1330 may be configured to perform the desired equalization. In one embodiment, S-C-T equalization is performed as described above with respect to FIG. 3. In an alternate embodiment, S-T equalization is performed, as described above with respect to FIG. 6. In yet another embodiment, C-T equalization is performed, as described above with respect to FIGS. 9 or 11. In the following discussion, S-C-T equalization, and the various alternatives described above are described in further detail. These alternatives may be deployed in a mobile station to utilize signals received from multiple transmit sector antennas, i.e., soft handoff.

The S-C-T equalizer operates by first correlating signals from adjacent sectors (decovering/recovering) with the base sector PN/Walsh cover. The decovered/recovered signals from adjacent sectors are treated as correlated signal inputs to the S-C-T algorithm. The signals from adjacent sectors are thereby used in a manner that yields a full receive equalization method for the mobile station in hand-off across antennas, sectors, and time.

In this discussion, an example multi-sector CDMA forward link with a per-sector frequency selective fading channel model and power control are assumed. Time resolvable multi-path (MP) is modeled on a power and time delay basis, each MP is fading and distributed in time, un-correlated with other MP.

The system discrete time index is n=1:N (N is the length of data, defined above) The information data signal is s₀(n), with symbol duration Tₛ=1:N₁, having Nb=N/N₁ total number of symbol bits. The data symbol Walsh cover is

$${{q}_{v}}_{1 \times {N}_{1}}$$

(index v) and

$${{p}_{u}}_{1 \times N}$$

is the u^{th} sector pilot PN sequence. Larger data symbol Walsh cover vectors are constructed for N_{b} data symbols by repeating the base 1×N₁ Walsh cover N_{b} times to obtain a 1×N data symbol Walsh cover vector. Pᵤ and Qᵥ are the N×N diagonal matrix equivalents of the Walsh cover vector and pilot PN sequence,

$${{p}_{u}}_{1 \times N} = {1}_{1 \times N} \cdot {{P}_{u}}_{N \times N} and {{q}_{v}}_{1 \times N} = {1}_{1 \times N} \cdot {{Q}_{v}}_{N \times N} .$$

The covered pilot and data transmit signal, per sector, is:

$${{d}_{u , v}}_{1 \times N} = [ {1}_{1 \times N} + {{s}_{0} ( n )}_{1 \times N} \cdot {{Q}_{v}}_{N \times N} ] \cdot {{P}_{u}}_{N \times N} \qquad ( 1 )$$

The continuous time low pass equivalent impulse response of the channel for sector u, h_{uM,L}(t, τ), has L independently fading ray paths or MP's from the u^{th} sector transmit antenna to the M MS receiving antennas. Each time resolvable MP has the un-correlated M×1 fading vector, \overline{c}. The equivalent discrete time channel in a M antenna by T₁ time delay matrix is defined as hᵤ(n), where the time delay of each MP corresponds to a specific column of hᵤ(n):

$${h}_{uM , L} ( t , τ ) = {\sum }_{l = 0}^{L - 1} {\vec{c}}_{u , l} δ ( t - {T}_{u , l} ) ⇒ {{h}_{u} ( n )}_{M \times {T}_{1}} = [ {\vec{c}}_{u , 0} {\vec{c}}_{u , 1} 0 … 0 {\vec{c}}_{u , L - 1} ] \qquad ( 2 )$$

The relative time constants in the channel are assumed such that time delays between the outermost MPs, τ₀−τ_{L-I}=1/B_{coh}, is smaller than the time associated with changes in channel coefficients, ΔT_{chan}=1/B_{Doppler}, where B_{Doppler}<<B_{coh}. By definition of B_{Doppler}, we define the channel state matrix to be coherent in discrete time notation up to time index N or in continuous time notation up to time duration ΔT_{chan}=1/B_{Doppler}. By definition of B_{Coh}, we define the memory of the channel in discrete time notation as T₁, with T₁<N, or in continuous time notation is on the order of τ₀−τ₁=1/B_{coh}.

Exciting or convolving the channel impulse response, hᵤ(n), for sector u with the corresponding u^{th} sector transmit waveform, d_{u,v}, yields the pilot and data signal channel state matrix for sector u with data Walsh cover v:

$${{H}_{u , v}}_{M \times ( N + {T}_{1} - 1 )} = {{d}_{u , v}}_{1 \times N} * {{h}_{u} ( n )}_{M \times {T}_{1}} \qquad ( 3 )$$

X is defined as the combination of H_{u,v} for all U sectors plus the complex Gaussian mobile station additive receiver noise matrix B:

$$\begin{matrix}{X}_{M \times ( N + {T}_{1} - 1 )} = {\sum }_{u = 0}^{U - 1} {{H}_{u , v}}_{M \times ( N + {T}_{1} - 1 )} + {B}_{M \times ( N + {T}_{1} - 1 )} \\ = [ {\vec{x}}_{1} {\vec{x}}_{2} … {\vec{x}}_{( N + {T}_{1} - 1 )} ] \\ = [ \begin{matrix}{x}_{0 , 1} & {x}_{0 , 2} & ⋯ & {x}_{0 , ( N + {T}_{1} - 1 )} \\ {x}_{1 , 1} & {x}_{1 , 2} & ⋯ & {x}_{1 , ( N + {T}_{1} - 1 )} \\ ⋮ & ⋮ & ⋰ & ⋮ \\ {x}_{M - 1 , 1} & {x}_{M - 1 , 2} & ⋯ & {x}_{M - 1 , ( N + {T}_{1} - 1 )}\end{matrix} ]\end{matrix} \qquad ( 4 )$$

where \overline{x}ₙ is a vector of all equivalent antenna samples for time index n.

Space-Cover-Time Equalizer

An example decover/recover method and S-C-T equalizer are defined in this section. As described above, in the S-C-T receiver, we first decover other sectors but then also recover the same other sectors with a base desired PN and Walsh cover to allow full equalization, in chip time, using signals from all sectors.

We describe Y(u) as the on-time decovered/recovered waveform for sector u assuming sector 0 is the base sector:

$${Y ( u )}_{M \times N} = {X}_{M \times N} \cdot {{G}_{u}}_{N \times N} \cdot {{G}_{0}}_{N \times N} \qquad ( 5 )$$

where Gᵤ is the generalized decover/recover matrix and

$${X}_{M \times N}$$

is defined as the on-time received signal and noise matrix (N time samples of X in (4)).

Gᵤ=Pᵤ when we only decover/recover the PN for sector u. When we decover/recover the PN and Walsh sequences for sector u using Walsh cover index v, G_{u,v}=Pᵤ·Qᵥ, and a Walsh index subscript is added to (5) as:

$${{Y}_{v} ( u )}_{M \times N} = {X}_{M \times N} \cdot {{G}_{u , v}}_{N \times N} \cdot {{G}_{0}}_{N \times N} \qquad ( 6 )$$

Y is defined as the combination of the on-time decovered/recovered receive signal sample matrices for all m antennas and u sectors (non-time dependent weight solutions):

$${Y}_{M \cdot U \times N} = [ \begin{matrix}{Y ( 0 )}_{M \times N} = {X}_{M \times N} \\ {Y ( 1 )}_{M \times N} \\ ⋮ \\ {Y ( U - 1 )}_{M \times N}\end{matrix} ] \qquad ( 7 )$$

Early/Late Received Data Sample Matrices

X is defined and obtained by stacking time advanced and delayed versions of the on-time M×N signal sample matrix X, to support matrix convolutions in determining a time dependent weight matrix with T₂ taps, as:

$${x}_{M \cdot {T}_{2} \times N} = [ \begin{matrix}X [ 1 ( {{T}_{2}}_{M \times N} ) / 2 ] \\ ⋮ \\ {X [ 1 ]}_{M \times N} \\ ⋮ \\ X [ 1 + ( {{T}_{2}}_{M \times N} - 1 ) / 2 ]\end{matrix} ] = [ \begin{matrix}{\vec{x}}_{1 - \frac{{T}_{2} - 1}{2}} & {\vec{x}}_{2 - \frac{{T}_{2} - 1}{2}} & ⋯ & {\vec{x}}_{N - 1 - \frac{{T}_{2} - 1}{2}} & {\vec{x}}_{N - \frac{{T}_{2} - 1}{2}} \\ ⋮ & ⋮ & ⋯ & ⋮ & ⋮ \\ {\vec{x}}_{1} & {\vec{x}}_{2} & ⋯ & {\vec{x}}_{N - 1} & {\vec{x}}_{N} \\ ⋮ & ⋮ & ⋯ & ⋮ & ⋮ \\ {\vec{x}}_{1 + \frac{{T}_{2} - 1}{2}} & {\vec{x}}_{2 + \frac{{T}_{2} - 1}{3}} & ⋯ & {\vec{x}}_{N - 1 + \frac{{T}_{2} - 1}{2}} & {\vec{x}}_{N + \frac{{T}_{2} - 1}{2}}\end{matrix} ] \qquad ( 8 )$$

X in (8) is decovered/recovered with G, like in (6), to obtain the u^{th} sector time dependent decovered/recovered signal sample matrix, Y(u):

$${Y ( u )}_{M \cdot {T}_{2} \times N} = {X}_{M \cdot {T}_{2} \times N} \cdot {{G}_{u}}_{N \times N} \cdot {{G}_{0}}_{N \times N} == [ \begin{matrix}{\vec{y}}_{u , 1 - \frac{{T}_{2} - 1}{2}} & {\vec{y}}_{u , 2 - \frac{{T}_{2} - 1}{2}} & ⋯ & {\vec{y}}_{u , N - 1 - \frac{{T}_{2} - 1}{2}} & {\vec{y}}_{u , N - \frac{{T}_{2} - 1}{2}} \\ ⋮ & ⋮ & ⋯ & ⋮ & ⋮ \\ {\vec{y}}_{u , 1} & {\vec{y}}_{u , 2} & ⋯ & {\vec{y}}_{u , N - 1} & {\vec{y}}_{u , N} \\ ⋮ & ⋮ & ⋯ & ⋮ & ⋮ \\ {\vec{y}}_{u , 1 + \frac{{T}_{2} - 1}{2}} & {\vec{y}}_{u , 2 + \frac{{T}_{2} - 1}{2}} & ⋯ & {\vec{y}}_{u , N - 1 + \frac{{T}_{2} - 1}{2}} & {\vec{y}}_{u , N + \frac{{T}_{2} - 1}{2}}\end{matrix} ] \qquad ( 9 )$$

Similar to (7), the per sector time dependent Y(u) signal samples are combined to form Y, for all m antennas and u sectors. Y supports the matrix convolutions required in the determination of a S-C-T weight matrix with T₂ time taps:

$${Y}_{M \cdot U \cdot {T}_{2} \times N} = [ \begin{matrix}{\vec{y}}_{0 , 1 - \frac{{T}_{2} - 1}{2}} & {\vec{y}}_{0 , 2 - \frac{{T}_{2} - 1}{2}} & ⋯ & {\vec{y}}_{0 , N - 1 - \frac{{T}_{2} - 1}{2}} & {\vec{y}}_{0 , N - \frac{{T}_{2} - 1}{2}} \\ ⋮ & ⋮ & ⋯ & ⋮ & ⋮ \\ {\vec{y}}_{U - 1 , 1 - \frac{{T}_{2} - 1}{2}} & {\vec{y}}_{U - 1 , 2 - \frac{{T}_{2} - 1}{2}} & ⋯ & {\vec{y}}_{U - 1 , N - 1 - \frac{{T}_{2} - 1}{2}} & {\vec{y}}_{U - 1 , N - \frac{{T}_{2} - 1}{2}} \\ ⋮ & ⋮ & ⋯ & ⋮ & ⋮ \\ {\vec{y}}_{0 , 1} & {\vec{y}}_{0 , 2} & ⋯ & {\vec{y}}_{0 , N - 1} & {\vec{y}}_{0 , N} \\ ⋮ & ⋮ & ⋯ & ⋮ & ⋮ \\ {\vec{y}}_{U - 1 , 1} & {\vec{y}}_{U - 1 , 2} & ⋯ & {\vec{y}}_{U - 1 , N - 1} & {\vec{y}}_{U - 1 , N} \\ ⋮ & ⋮ & ⋯ & ⋮ & ⋮ \\ {\vec{y}}_{0 , 1 + \frac{{T}_{2} - 1}{2}} & {\vec{y}}_{0 , 2 + \frac{{T}_{2} - 1}{2}} & ⋯ & {\vec{y}}_{0 , N - 1 + \frac{{T}_{2} - 1}{2}} & {\vec{y}}_{0 , N + \frac{{T}_{2} - 1}{2}} \\ ⋮ & ⋮ & ⋯ & ⋮ & ⋮ \\ {\vec{y}}_{U - 1 , 1 + \frac{{T}_{2} - 1}{2}} & {\vec{y}}_{U - 1 , 2 + \frac{{T}_{2} - 1}{2}} & ⋯ & {\vec{y}}_{U - 1 , N - 1 + \frac{{T}_{2} - 1}{2}} & {\vec{y}}_{U - 1 , N + \frac{{T}_{2} - 1}{2}}\end{matrix} ] \qquad ( 10 )$$

Least Squares S-C-T Equalizer

We use a base sector PN sequence, p₀, as our desired reference signal and seek to find the best linear weight solution, W, that minimizes the Least Square (LS) error between the output sequence estimate, \hat{p}₀, and the input sequence \hat{p}₀. We note the LS solution approaches the Minimum Mean Square Error solution as the time index N increases to where sufficient estimates of the second order statistics are obtained (ergodicity).

The S-C-T weight matrix W is described in matrix form with tap length or a memory in time of T₂ where T₁≦T₂≦N:

$${W}_{M \cdot U \times {T}_{2}} = [ \begin{matrix}{\vec{w}}_{0 , 1} & {\vec{w}}_{0 , 2} & ⋯ & {\vec{w}}_{0 , {T}_{2}} \\ {\vec{w}}_{1 , 1} & {\vec{w}}_{1 , 2} & ⋯ & {\vec{w}}_{1 , {T}_{2}} \\ ⋮ & ⋮ & ⋰ & ⋮ \\ {\vec{w}}_{M - 1 , 1} & {\vec{w}}_{M - 1 , 2} & ⋯ & {\vec{w}}_{M - 1 , {T}_{2}}\end{matrix} ] \qquad ( 11 )$$

where \overline{w}_{m,i} is the U×1 weight vector (in Cover domain) for antenna m=0:M-1 at relative time index i.

Redefining \overline{w}_{m,i}, into a new M·U×1 vector \overline{w}ᵢ at relative time index i:

$${{\vec{w}}_{1}}_{M \cdot U \times 1} = {[ \begin{matrix}{\vec{w}}_{0 , i}^{H} & {\vec{w}}_{1 , i}^{H} & ⋯ & {\vec{w}}_{M - 1 , i}^{H}\end{matrix} ]}^{H} \qquad ( 12 )$$

Equation (12) is mapped into the single column equivalent:

$${w}_{M \cdot U \cdot {T}_{2} \times 1} = {[ {\vec{w}}_{1}^{H} {\vec{w}}_{2}^{H} … {\vec{w}}_{{T}_{2}}^{H} ]}^{H} \qquad ( 13 )$$

for all m=0:M-1 antennas, u=0:U-1 sectors, with temporal memory or relative time index i=0:T₂−1.

The error term, e, is defined as the difference between the estimate of the PN reference, \hat{p}₀, and the true PN reference:

$$\begin{matrix}{{\hat{p}}_{0}}_{1 \times N} = Tr ( {W}^{H} Y ) = {W}^{H} Y & ( 14 ) \\ {e}_{1 \times N} = {p}_{0} - {\hat{p}}_{0} = {p}_{0} - {W}^{H} Y & ( 15 )\end{matrix}$$

Using the orthogonality principle, the error energy (sum of squared errors) is minimized over all m=0:M-1 antennas, u=0:U-1 sectors, and n=1:N time samples. The S-C-T weight matrix is applied to the signal samples over time 1≦n≦N.

Assuming that Y·Y^{H} is non-singular and invertible, we solve for the general LS error S-C-T weight solution as:

$${w}_{M \cdot U \cdot {T}_{2} \times 1} = {( {Y}_{M \cdot U \cdot {T}_{2} \times N} \cdot {{Y}_{H}}_{N \times M \cdot U \cdot {T}_{2}} )}^{- 1} \cdot {Y}_{M \cdot U \cdot {T}_{2} \times N} \cdot {{p}_{0}^{H}}_{N \times 1} \qquad ( 16 )$$

The pseudo-inverse of Y·Y^{H} or other like algorithms, known in the art, apply to (16).

Using (16), the estimate of the base PN sequence is:

$${{\hat{p}}_{0}}_{1 \times N} = {{w}^{H}}_{1 \times M \cdot U \cdot {T}_{2}} \cdot {Y}_{M \cdot U \cdot {T}_{2} \times N} = {{p}_{0}}_{1 \times N} \cdot {{{Y}_{H}}_{N \times M \cdot U \cdot {T}_{2}} ( {Y}_{M \cdot U \cdot {T}_{2} \times N} \cdot {{Y}^{H}}_{N \times M \cdot U \cdot {T}_{2}} )}^{- 1} \cdot {Y}_{M \cdot U \cdot {T}_{2} \times N} \qquad ( 17 )$$

Using the modified version Yᵥ from (6) that accounts for changes in Walsh covers and (16), the time sampled estimate of the desired data symbol stream, ŝ₀(n), is determined as:

$${{\hat{s}}_{0} ( n )}_{1 \times {N}_{1}} = \underbrace{[ {{w}^{H}}_{1 \times M \cdot U \cdot {T}_{2}} \cdot {{Y}_{V}}_{M \cdot U \cdot {T}_{2} \times {N}_{1}} ]}_{S - C - T Combined Output} \cdot \underbrace{{{P}_{0}}_{{N}_{1} \times {N}_{1}} \cdot {{Q}_{0}}_{{N}_{1} \times {N}_{1}}}_{De - cover PN / Walsh} \qquad ( 18 )$$

where the time index, N₁, in (18) is used for decovered data symbol time durations that are smaller than the time duration used in the weight calculation, N, with N₁≦N.

Space-Time and Cover-Time Equalizers

A typical S-T only weight matrix for sector u, Wᵤ, is:

$${W}_{{u}_{M \times {T}_{2}}} = [ {\vec{w}}_{1} {\vec{w}}_{2} … {\vec{w}}_{{T}_{2}} ] = [ \begin{matrix}{w}_{0 , 1} & {w}_{0 , 2} & … & {w}_{0 , {T}_{2}} \\ {w}_{1 , 1} & {w}_{1 , 2} & … & {w}_{1 , {T}_{2}} \\ ⋮ & ⋮ & ⋰ & ⋮ \\ {w}_{M - 1 , 1} & {w}_{M - 1 , 2} & … & {w}_{M - 1 , {T}_{2}}\end{matrix} ] \qquad ( 19 )$$

where we can redefine Wᵤ into wᵤ, a single column vector format for the u^{th} sector S-T weight solution:

$${W}_{{u}_{M \cdot {T}_{2} \times 1}} = {[ {\vec{w}}_{1}^{H} {\vec{w}}_{2}^{H} … {\vec{w}}_{{T}_{2}}^{H} ]}^{H} \qquad ( 20 )$$

to aid in the matrix analysis of the convolution of W and X. The LS solution for wᵤ is:

$${W}_{{u}_{M \cdot {T}_{2} \times 1}} = {( {X}_{M \cdot {T}_{2} \times N} \cdot {{X}^{H}}_{N \times M \cdot {T}_{2}} )}^{- 1} \cdot {X}_{M \cdot {T}_{2} \times N} \cdot {{p}_{u}^{H}}_{N \times 1} \qquad ( 21 )$$

The u^{th} sector S-T pilot estimate,

$${{\hat{p}}_{u}}_{1 \times N} = Tr ( {W}_{u}^{H} X ) - {W}_{u}^{H} X ,$$

fails to include equalization across the Cover domain and hence is sub-optimal where each sector is independently analyzed (with combining after decover). A Cover domain RAKE combiner may be used after the S-T equalizer outputs to combine all sectors. The RAKE uses an Optimal Combining (OC) weight that is rooted in a time independent LS solution.

In a manner similar to the S-T equalizer, we calculate a per antenna C-T equalizer weight using the recovered/decovered signal matrix (10). Defining

$${{Z}_{m}}_{U \cdot {T}_{2} \times N}$$

as grouping of

$${Y}_{M \cdot U \cdot {T}_{2} \times N}$$

by all sectors per antenna, we define the LS single column vector format for the m^{th} antenna C-T weight as:

$${{W}_{m}}_{U \cdot {T}_{2} \times 1} = {( {Z}_{U \cdot {T}_{2} \times N} \cdot {{Z}^{H}}_{N \times U \cdot {T}_{2}} )}^{- 1} \cdot {Z}_{U \cdot {T}_{2} \times N} \cdot {{p}_{0}^{H}}_{N \times 1} \qquad ( 22 )$$

The m^{th} sector C-T pilot estimate,

$${{\hat{p}}_{0 , m} = Tr ( {W}_{m}^{H} Z ) = {W}_{m}^{H} Z ,}_{1 \times N}$$

may use a Spatial domain RAKE, or other combiner 920, described above, to combine all antenna outputs. Like the Cover domain RAKE used with the S-T equalizer, the spatial domain RAKE uses an OC weight.

The S-C-T equalizing receiver has been described for a mobile station 106 in multi-sector handoff encountering frequency selective channels. Using a decover/recover method, the different sector transmitted waveforms may be correlated using a Least Squares (or alternate method) S-C-T weight solution across all antennas, sectors, and time.

Adjacent sector transmit antennas represent an extra degree of freedom to the mobile station during handoff. The typical per sector S-T equalizer sees adjacent sector signals only as co-channel interference whereas the S-C-T multi-sensor/sector equalizer structure may incorporate the adjacent sector information into the final equalizing solution.

FIG. 14 depicts a flowchart of a more detailed example embodiment of a method of S-C-T equalization. The process begins at step 510, where signals are received from M antennas, as described above with respect to like-numbered steps. The matrix formed may correspond to equation 4, above. Proceed to step 1410. In step 1410, time advanced and delayed copies of the received signal matrix may be formed, the combination of which forms matrix X. (See equation (8), above, for example). Those of skill in the art will recognize that time advances and delays, in the context of covering or decovering, may be performed by sampling the input signals and taking segments that are time offset from each other, or, equivalently, the PN or Walsh sequences may be advanced or retarded instead, to produce varying time offset sequences. Proceed to step 1420.

In step 1420, generate PN and Walsh cover matrices for U sectors. (See equations 5 and 6, above). Those of skill in the art will recognize that manipulations of these matrices, as described herein, may be carried out serially as shown above with the example decover/recover block 310, described above, as an alternative to matrix operation computations. Proceed to step 1430. In step 1430, decover/recover matrix X using the PN cover matrix, to form matrix Y. (See equations 9-10, above, for example). Proceed to step 1440. In step 1440, decover/recover Y with the Walsh cover matrix, to form matrix Y_{V}. (See equation 6, above, for example.) Proceed to step 1450.

In step 1450, weights are generated by minimizing Euclidean distance between the reference signal and an estimate. (See equations 11-17, above, for example.) Calculate weight matrix W from Y via matrix inversion, singular decomposition, pseudo-inverse, or other decomposition methods known or yet to be developed in the art. Proceed to step 1460.

In step 1460, multiply Y_{V} by W to form the received signal estimate. (See equation 18, above, for example.) In an example embodiment, this is carried out using an FIR filter, with taps determined by weight matrix W, and Y_{V} as the input. Note that the equalizer may be configured to decover the base PN and Walsh codes, or such decovering may occur subsequently (details not shown.) Then the process may stop. Note that equalization will produce received signal estimates which can be delivered for further demodulation, such as accumulation of a symbol, deinterleaving, decoding, and various other demodulation techniques known in the art. The process depicted in FIG. 14 may be repeated indefinitely for as long as a mobile station desires to receive a transmitted channel (details not shown). Alternatively, any iterative period can be deployed. As an example, the equalizer may be updated every N time samples, where N corresponds to changing channel conditions.

It should be noted that in all the embodiments described above, method steps may be interchanged without departing from the scope of the invention. The descriptions disclosed herein have in many cases referred to signals, parameters, and procedures associated with one or more CDMA standards detailed above, but the scope of the present invention is not limited as such. Those of skill in the art will readily apply the principles herein to various other communication systems. These and other modifications will be apparent to those of ordinary skill in the art.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus, comprising:
a decoverer/recoverer for decovering each of one or more signals from one or more antennas with each of a plurality of codes corresponding to a plurality of coded transmission channels and for recovering each of the decovered signals with a base code to form a plurality of decovered/recovered signals.

2. The apparatus of claim 1, wherein the decoverer/recoverer generates respective signals for each antenna and code for an on-time time offset, one or more early time offsets, and one or more late time offsets.

3. The apparatus of claim 1, further comprising:
an equalizer for equalizing the plurality of decovered/recovered signals using the base code as a reference.

4. The apparatus of claim 3, wherein the equalizer is a space-cover-time-equalizer.

5. The apparatus of claim 3, wherein the equalizer minimizes the Least Square (LS) error between the equalizer output and the reference.

6. The apparatus of claim 3, wherein the equalizer minimizes the Minimum Mean Square Error (MMSE) error between the equalizer output and the reference.

7. The apparatus of claim 3, wherein the decoverer/recoverer passes through the one or more signals from the one or more antennas to generate the respective portion of the plurality of decovered/recovered signals corresponding to the base code.

8. The apparatus of claim 1, wherein the decoverer/recoverer generates the respective portion of the plurality of decovered/recovered signals corresponding to one of the plurality of codes by multiplying the one or more signals by the product of the respective one of the plurality of codes and the base code.

9. The apparatus of claim 1, further comprising:
a sector combiner for combining the respective portions of the plurality of decovered/recovered signals corresponding to each of the one or more antennas to form one or more sector-combined decovered/recovered signals, the number of sector-combined decovered/recovered signals equal to the number of antennas; and
a space-time equalizer for equalizing the one or more sector-combined decovered/recovered signals using the base code as a reference.

10. The apparatus of claim 9, wherein the base code is one of the plurality of codes.

11. The apparatus of claim 9, wherein the sector combiner sums the respective portions of the plurality of decovered/recovered signals corresponding to each of the one or more antennas to form the one or more sector-combined decovered/recovered signals.

12. The apparatus of claim 1, further comprising:
one or more cover-time equalizers, each corresponding to one of the one or more antennas, each cover-time equalizer for equalizing a respective group of the plurality of decovered/recovered signals using the base code as a reference, each respective group including the plurality of decovered/recovered signals generated in response to the plurality of codes for the respective antenna; and
a combiner for combining the one or more outputs of the one or more cover-time equalizers.

13. The apparatus of claim 12, wherein the base code is one of the plurality of codes.

14. The apparatus of claim 3, wherein the equalizer comprises:
a tap processor for generating a plurality of weights in response to the plurality of decovered/recovered signals and the base code;
a decoverer for decovering the plurality of decovered/recovered signals according to respective codes of a plurality of cover codes corresponding to the plurality of transmission channels to form a plurality of cover decoded signals; and
a Finite Impulse Response (FIR) filter for filtering the plurality of covered decoded signals in response to the plurality of weights to form a received signal estimate.

15. The apparatus of claim 14, wherein the tap processor generates the plurality of weights by minimizing the LS error between plurality of decovered/recovered signals and the reference.

16. The apparatus of claim 14, wherein the tap processor generates the plurality of weights by minimizing the MMSE error between plurality of decovered/recovered signals and the reference.

17. The apparatus of claim 1, wherein the plurality of codes comprises unique Pseudorandom Noise (PN) sequences corresponding to each of the coded transmission channels.

18. The apparatus of claim 14, wherein the plurality of cover codes comprises one or more Walsh sequences.

19. The apparatus of claim 14, wherein the plurality of cover codes comprises one or more Orthogonal Variable Spreading Factor (OVSF) sequences.

20. An apparatus, comprising:
a decoverer/recoverer for decovering a signal from one antenna with each of a plurality of codes corresponding to a plurality of coded transmission channels and for recovering each of the decovered signals with a base code to form a plurality of decovered/recovered signals;
a cover-time equalizer for equalizing the plurality of decovered/recovered signals using the base code as a reference.

21. The apparatus of claim 20, wherein the base code is one of the plurality of codes.

22. The apparatus of claim 20, wherein the decoverer/recoverer generates respective signals for each code for an on-time time offset, one or more early time offsets, and one or more late time offsets.

23. A wireless communication device, comprising:
a decoverer/recoverer for decovering each of one or more signals from one or more antennas with each of a plurality of codes corresponding to a plurality of coded transmission channels and for recovering each of the decovered signals with a base code to form a plurality of decovered/recovered signals.

24. The wireless communication device of claim 23, further comprising:
an equalizer for equalizing the plurality of decovered/recovered signals using the base code as a reference.

25. A wireless communication system, comprising:
a decoverer/recoverer for decovering each of one or more signals from one or more antennas with each of a plurality of codes corresponding to a plurality of coded transmission channels and for recovering each of the decovered signals with a base code to form a plurality of decovered/recovered signals.

26. The wireless communication device of claim 25, further comprising:
an equalizer for equalizing the plurality of decovered/recovered signals using the base code as a reference.

27. A method of receiving a plurality of coded transmission channels with one or more antennas, comprising:
decovering the signals received at each of the one or more antennas with a plurality of codes corresponding to the plurality of coded transmission channels; and
recovering the decovered signals with a base code.

28. The method of claim 27, wherein the base code is one of the plurality of codes.

29. The method of claim 27, further comprising equalizing the recovered signals using the base code as a reference.

30. The method of claim 27, wherein the decovering is performed at an on-time time offset, one or more early time offsets, and one or more late time offsets, and wherein the recovering is performed on the on-time, early, and late decovered signals.

31. The method of claim 29, wherein the equalization is space-cover-time equalization.

32. The method of claim 27, further comprising:
combining the recovered signals corresponding to each of the one or more antennas to form one or more sector-combined recovered signals; and
space-time equalizing the one or more sector-combined recovered signals using the base code as a reference.

33. The method of claim 27, further comprising:
grouping the recovered signals according to respective antennas;
cover-time equalizing each antenna group of recovered signals using the base signal as a reference; and
combining the cover-time equalizer results corresponding to each antenna to form a received signal estimate.

34. A method of receiving a plurality of coded transmission channels with one antenna, comprising:
decovering the signal received at the antenna with a plurality of codes corresponding to the plurality of coded transmission channels;
recovering the decovered signals with a base code; and
cover-time equalizing the recovered signals using the base signal as a reference.

35. The method of claim 34, wherein the cover-time equalization is performed using an FIR filter.

36. A method of receiving a plurality of coded transmission channels with one or more antennas, comprising:
storing samples received through the one or more antennas to form a received signal matrix;
generating a PN cover code matrix with code values according to the plurality of coded transmission channels, the code values multiplied by a base code;
generating a Walsh cover code matrix with code values according to the plurality of coded transmission channels;
decovering/recovering the received signal matrix with the PN cover code matrix to form a first decovered/recovered matrix;
decovering/recovering the first decovered/recovered matrix with the Walsh cover code matrix to form a second decovered/recovered matrix;
generating a weight matrix from the first decovered/recovered matrix using the base code as a reference; and
multiplying the second decovered/recovered matrix by the weight matrix to produce a received signal estimate.

37. The method of claim 36, wherein the received signal matrix includes time advanced and delayed copies of the received samples.

38. The method of claim 36, wherein the PN cover matrix and the Walsh cover matrix include time advanced and delayed copies of portions of the PN and Walsh sequences, respectively.

39. The method of claim 36, wherein the weights are generated by minimizing Euclidean distance between the reference and a signal estimate.

40. The method of claim 36, wherein the weight matrix is generated by matrix inversion of the first decovered/recovered matrix.

41. The method of claim 36, wherein the weight matrix is generated by singular decomposition of the first decovered/recovered matrix.

42. The method of claim 36, wherein the weight matrix, is generated by pseudo-inverse of the first decovered/recovered matrix.

43. The method of claim 36, wherein the multiplying step is performed with an FIR filter with tap values determined in accordance with the weight matrix, the input to the FIR filter being the second decovered/recovered matrix.

44. An apparatus, comprising:
means for decovering signals received at each of one or more antennas with a plurality of codes corresponding to a plurality of coded transmission channels; and
means for recovering the decovered signals with a base code.

45. The apparatus of claim 44, further comprising means for equalizing the recovered signals using the base code as a reference.

46. The apparatus of claim 44, further comprising means for space-cover-time equalizing the recovered signals using the base code as a reference.

47. The apparatus of claim 44, further comprising:
means for combining the recovered signals corresponding to each of the one or more antennas to form one or more sector-combined recovered signals; and
means for space-time equalizing the one or more sector-combined recovered signals using the base code as a reference.

48. The apparatus of claim 44, further comprising:
means for grouping the recovered signals according to respective antennas;
means for cover-time equalizing each antenna group of recovered signals using the base signal as a reference; and
means for combining the cover-time equalizer results corresponding to each antenna to form a received signal estimate.

49. An apparatus, comprising:
means for decovering signals received at one antenna with a plurality of codes corresponding to a plurality of coded transmission channels;
means for recovering the decovered signals with a base code; and
means for cover-time equalizing the recovered signals using the base signal as a reference to form a received signal estimate.

50. A wireless communication system, comprising:
means for decovering signals received at each of one or more antennas with a plurality of codes corresponding to a plurality of coded transmission channels; and
means for recovering the decovered signals with a base code.

51. The wireless communication system of claim 50, further comprising means for space-cover-time equalizing the recovered signals using the base code as a reference.

52. The wireless communication system of claim 50, further comprising:
means for combining the recovered signals corresponding to each of the one or more antennas to form one or more sector-combined recovered signals; and
means for space-time equalizing the one or more sector-combined recovered signals using the base code as a reference.

53. The wireless communication system of claim 50, further comprising:
means for grouping the recovered signals according to respective antennas;
means for cover-time equalizing each antenna group of recovered signals using the base signal as a reference; and
means for combining the cover-time equalizer results corresponding to each antenna to form a received signal estimate.

54. A wireless communication system, comprising:
means for decovering signals received at one antenna with a plurality of codes corresponding to a plurality of coded transmission channels;
means for recovering the decovered signals with a base code; and
means for cover-time equalizing the recovered signals using the base signal as a reference to form a received signal estimate.

55. Processor readable media operable to perform the following steps:
decovering signals received at each of one or more antennas with a plurality of codes corresponding to a plurality of coded transmission channels; and
recovering the decovered signals with a base code.

56. The processor readable media of claim 55 operable to perform the further step of equalizing the recovered signals using the base code as a reference.

57. The processor readable media of claim 55 operable to perform the further following steps:
combining the recovered signals corresponding to each of the one or more antennas to form one or more sector-combined recovered signals; and
space-time equalizing the one or more sector-combined recovered signals using the base code as a reference.

58. The processor readable media of claim 55 operable to perform the further following steps:
grouping the recovered signals according to respective antennas;
cover-time equalizing each antenna group of recovered signals using the base signal as a reference; and
combining the cover-time equalizer results corresponding to each antenna to form a received signal estimate.

59. Processor readable media operable to perform the following steps:
storing samples received through one or more antennas to form a received signal matrix;
generating a PN cover code matrix with code values according to a plurality of coded transmission channels, the code values multiplied by a base code;
generating a Walsh cover code matrix with code values according to the plurality of coded transmission channels;
decovering/recovering the received signal matrix with the PN cover code matrix to form a first decovered/recovered matrix;
decovering/recovering the first decovered/recovered matrix with the Walsh cover code matrix to form a second decovered/recovered matrix;
generating a weight matrix from the first decovered/recovered matrix using the base code as a reference; and
multiplying the second decovered/recovered matrix by the weight matrix to produce a received signal estimate.
